(19) United States
(12) Patent Application Publication
(10) Pub. No.: US 2025/0371690 A1
(43) Pub. Date: Dec. 4, 2025

(54) THREE-DIMENSIONALIZATION SYSTEM, THREE-DIMENSIONALIZATION METHOD, AND RECORDING MEDIUM FOR GENERATING MODEL OF ROAD SURFACE OR STRUCTURE ON ROAD

(71) Applicant: NEC Corporation, Minato-ku, Tokyo (JP)

(72) Inventors: Yuta SHIMIZU, Tokyo (JP); Chisato SUGAWARA, Tokyo (JP); Yusuke MIZUKOSHI, Tokyo (JP); Yoshihiro NISHIKAWA, Tokyo (JP)

(73) Assignee: NEC Corporation, Minato-ku, Tokyo (JP)

(21) Appl. No.: 18/873,772

(22) PCT Filed: Sep. 22, 2022
(86) PCT No.: PCT/JP2022/035391

§ 371 Date: Dec. 11, 2024

(51) Int. Cl. G06T 7/00; G06T 7/55; G06T 17/00

(52) U.S. Cl. CPC G06T 7/0002; G06T 7/55; G06T 17/00; G06T 2207/30184; G06T 2207/30256

(57) ABSTRACT

A three-dimensionalization system according to an aspect of the present disclosure includes: at least one memory storing instructions; and at least one processor configured to execute the instructions to acquire a plurality of images captured by imaging devices each installed on each of a plurality of moving bodies, select at least two images obtained by capturing a road surface of a road or a structure on the road from among the plurality of acquired images based on a predetermined condition, and generate a three-dimensional model of the captured road surface of the road or the captured structure on the road using the selected images.

### TECHNICAL FIELD

The present disclosure relates to a three-dimensionalization system and the like.

### BACKGROUND ART

A structure disposed on a road body or around the road is damaged due to aged deterioration or an accident, and thus requires repair work. Three-dimensional data of a road and a structure may be used to support planning of repair work.

PTL 1 discloses a three-dimensional model construction system that collects imaging data captured by an imaging device provided in each of a plurality of moving bodies and generates a three-dimensional model. In PTL 1, an imaging region of an existing three-dimensional model is specified using supplementary information regarding imaging included in imaging data, and the existing three-dimensional model is updated using new imaging data in the imaging region.

### CITATION LIST

### Patent Literature

PTL 1: JP 2021-177317 A

PTL 2: JP 2019-164018 A

PTL 3: JP 2018-119927 A

### SUMMARY OF INVENTION

### Technical Problem

According to PTL 1, a three-dimensional model can be generated with a large fixed object such as a road, a building, or a bridge.

However, it is difficult to generate a three-dimensional model capable of identifying a deterioration state of a small object such as a road surface of a road or a structure on the road only by simply collecting images obtained by capturing the same region.

An object of the present disclosure is to provide a three-dimensionalization system or the like that enables generation of a highly accurate three-dimensional model.

### Solution to Problem

A three-dimensionalization system according to the present disclosure includes: an acquisition means that acquires a plurality of images captured by imaging devices each installed on each of a plurality of moving bodies; a selection means that selects at least two images capturing a road surface of a road or a structure on the road from among the plurality of acquired images based on a predetermined condition; and a generation means that uses the selected images to generate a three-dimensional model of the captured road surface of the road or the structure on the road.

A three-dimensionalization method according to the present disclosure includes: acquiring a plurality of images captured by imaging devices each installed on each of a plurality of moving bodies; selecting at least two images obtained by capturing a road surface of a road or a structure on the road from among the plurality of acquired images based on a predetermined condition; and generating a three-dimensional model of the captured road surface of the road or the captured structure on the road using the selected images.

A program according to the present disclosure causes a computer to execute: acquiring a plurality of images captured by imaging devices each installed on each of a plurality of moving bodies; selecting at least two images obtained by capturing a road surface of a road or a structure on the road from among the plurality of acquired images based on a predetermined condition; and generating a three-dimensional model of the captured road surface of the road or the captured structure on the road using the selected images. The program may be stored in a non-transitory recording medium which can be computer-readable. Advantageous Effects of Invention

According to the present disclosure, it is possible to generate a highly accurate three-dimensional model.

### BRIEF DESCRIPTION OF DRAWINGS

FIG. 1 is a diagram illustrating an outline of a device connected to a three-dimensionalization system.

FIG. 2 is a block diagram illustrating a configuration example of a three-dimensionalization system according to a first example embodiment.

FIG. 3 is a flowchart illustrating an operation example of the three-dimensionalization system according to the first example embodiment.

FIG. 4 is a table illustrating an example of information included in imaging data.

FIG. 5 is a block diagram illustrating an example of a hardware configuration of a computer.

### EXAMPLE EMBODIMENTS

On a road surface of a paved road, deterioration such as cracking, pot holes, rutting, and the like occurs due to factors such as traveling of a vehicle and rainfall. Structures on roads such as signs, lightings, guardrails, and curbstones are also deteriorated or damaged. Therefore, in order to grasp a deterioration situation of a road or a structure and plan repair of the road or the structure, a situation of the road is analyzed.

A three-dimensionalization system according to the present disclosure generates a three-dimensional model of a road surface of a road or a structure on the road using an image selected based on a predetermined condition from images captured by imaging devices installed in a plurality of moving bodies.

The road targeted by the three-dimensionalization system according to the present disclosure is not limited to a road on which vehicles pass, and includes a road on which people pass. A range to be three-dimensionalized by the three-dimensionalization system is not limited to a road main body, and includes a slope of a road and a land where a structure necessary for road management exists.

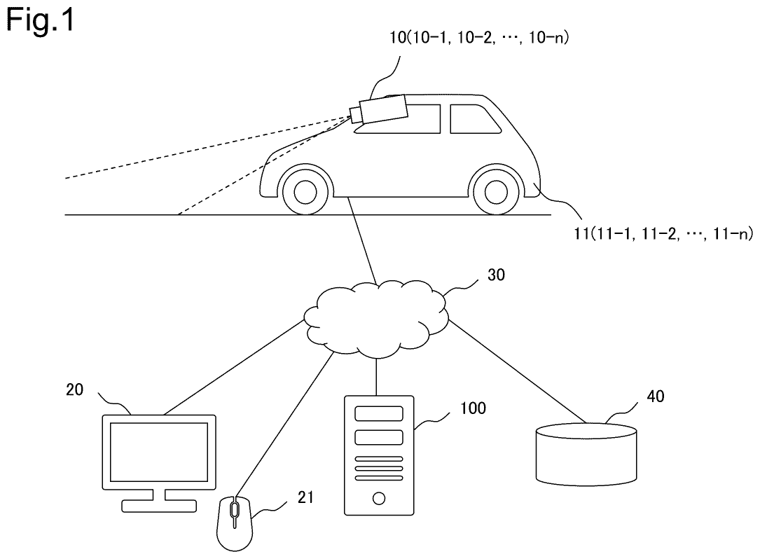

FIG. 1 is a diagram illustrating an outline of a device communicably connected to a three-dimensionalization system 100 by wire or wirelessly via a communication network 30. The three-dimensionalization system 100 is connected to, for example, an imaging device 10, a display 20, an input device 21, and a database 40.

The imaging device 10 is installed in a moving body 11, and captures an image including a road or a structure on the road. The imaging device 10 is achieved by, for example, a drive recorder mounted on an automobile. However, the type of the imaging device 10 is not limited thereto, and cameras provided in various types of moving bodies 11 may be used. For example, the image may be captured by a camera mounted on another moving body such as a bicycle or a drone.

The image captured by the imaging device 10 may be a still image or a moving image captured while the moving body 11 is moving. The image may be captured at a place designated by a person, or may be automatically captured at an arbitrary interval.

In FIG. 1, one imaging device 10 and one moving body 11 are illustrated. However, the three-dimensionalization system 100 may be connected to a plurality of imaging devices 10-1, . . . , 10-n installed in a plurality of moving bodies 11-1, . . . , 11-n. Here, n is a natural number of 2 or more. Each of the plurality of moving bodies 11 may be of the same type or different types. Each of the plurality of imaging devices 10 may be the same model or different models.

The imaging data including an image captured by the imaging device 10 is stored in the database 40. The imaging device 10 may transmit imaging data including an image to the three-dimensionalization system 100.

The imaging data may further include the following imaging conditions of an image. For example, the imaging data may include an identifier for identifying the imaging device 10 that has captured the image. The imaging data may include position information of a point where the image is captured. The position information includes, for example, latitude and longitude, position information obtained by a global navigation satellite system (GNSS) or a global positioning system (GPS), or a position on a map. The imaging data may include time information regarding the date and time when the image is captured.

The imaging data may include an imaging direction in which an image is captured. The imaging direction includes, for example, an azimuth or an elevation/depression angle in which the imaging device 10 is directed. The imaging direction can be acquired by a sensor provided in the imaging device 10. The imaging direction can be acquired based on the traveling direction of the moving body 11 in a case where the installation direction of the imaging device 10 with respect to the moving body 11 is defined.

The display 20 displays information to the user. The display 20 includes, for example, a display, a tablet, and the like. The information to be displayed will be described later.

The input device 21 receives an operation from a user. The input device 21 includes, for example, a mouse, a keyboard, and the like. In a case where the display 20 is a touch panel display, the display 20 may be configured as the input device 21.

The database 40 stores imaging data including an image captured by the imaging device 10.

### First Example Embodiment

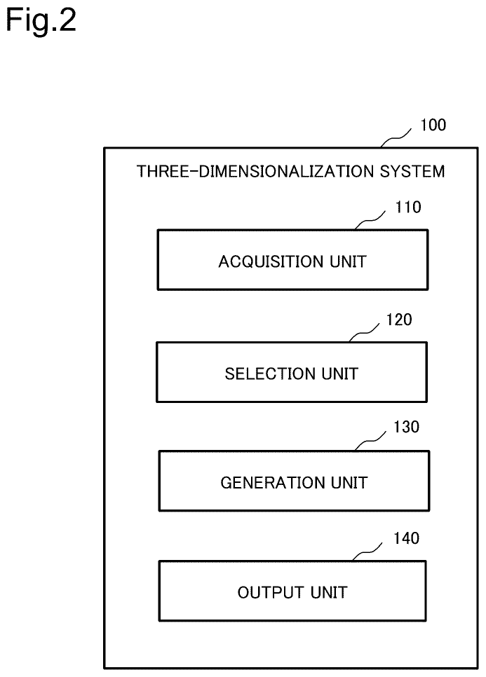

FIG. 2 is a block diagram illustrating a configuration example of the three-dimensionalization system 100 according to a first example embodiment. The three-dimensionalization system 100 includes an acquisition unit 110, a selection unit 120, and a generation unit 130. The three-dimensionalization system 100 further includes an output unit 140 as necessary.

The acquisition unit 110 acquires a plurality of images captured by the imaging device 10 installed in each of the plurality of moving bodies 11 and including an image obtained by capturing a predetermined point. The predetermined point is a point at which the three-dimensional model is to be generated. The range of the point where the acquisition unit 110 acquires the image can be appropriately set.

In one example, the acquisition unit 110 may acquire a moving image obtained by capturing a predetermined point. The acquisition unit 110 may extract and acquire a still image obtained by capturing a predetermined point from each of the plurality of moving images.

The acquisition unit 110 may acquire imaging data including an image. That is, the acquisition unit 110 may acquire the position information of the point where the image has been captured, the capturing date and time, the model information of the imaging device 10, and the like together with the image.

The selection unit 120 selects at least two images obtained by capturing a road surface of a road or a structure on the road based on a predetermined condition from the plurality of acquired images.

The predetermined condition is a condition for selecting an image suitable for generating a three-dimensional model of a road surface of a road or a structure on the road. The three-dimensional model is data representing the three-dimensional shape and size of the object. The three-dimensional model is, for example, three-dimensional point group information. The images suitable for generating the three-dimensional model are at least two images from which information required for calculating the three-dimensional shape and size of the object can be sufficiently acquired. An image suitable for generating a three-dimensional model includes an image that is expected to have parallax with respect to an object.

Recesses and protrusions may be generated on a road surface of a road due to road deterioration. The selection unit 120 may select an image suitable for estimating the depth of road deterioration as an image suitable for generating a three-dimensional model of the road surface of the road. The road deterioration includes, for example, cracking, pot holes, and rutting.

A structure on a road is an object installed near the road through which a vehicle or a person passes. The structure on the road includes, for example, a sign, a light, a guardrail, a curbstone, and the like.

For example, the selection unit 120 selects at least two images based on the acquired imaging data and a predetermined condition. Details of the predetermined condition will be described in a second example embodiment.

The selection unit 120 may select, from the images acquired by the acquisition unit 110, an image obtained by capturing the same point and satisfying the predetermined condition. For example, the selection unit 120 refers to the position information of the imaging data and extracts images obtained by capturing the same point. The selection unit 120 may extract an image obtained by capturing the same point by estimating a captured point based on the feature amount of the image. Then, the selection unit 120 may select at least two images that satisfy a predetermined condition from among the extracted images.

Alternatively, the selection unit 120 may select an image obtained by capturing the same point after extracting an image satisfying a predetermined condition.

The generation unit 130 uses at least two images selected by the selection unit 120 to generate a three-dimensional model of the captured road surface of a road or the captured structure on the road. For example, the generation unit 130 acquires parameters necessary for processing the parallax of the selected image. The necessary parameters are, for example, the distance between the imaging devices 10 and the focal length of the imaging device 10. Then, the generation unit 130 generates a three-dimensional model by calculating the distance from the imaging device 10 to the captured object based on the acquired parameter and the parallax of the selected image.

The generation unit 130 may generate a three-dimensional model indicating the depth of road deterioration as a three-dimensional model of the road surface of the road. The depth of road deterioration includes a depth of cracking, a depth of a pot hole, and a rutting amount.

The output unit 140 outputs information to the display 20 based on the generated three-dimensional model. For example, the output unit 140 may display the three-dimensional model on the display 20. The output unit 140 may output a value of the depth of road deterioration. The depth of road deterioration is calculated, for example, based on a change in depth of a portion obtained by cutting the three-dimensional model in a stripe shape in the road width direction.

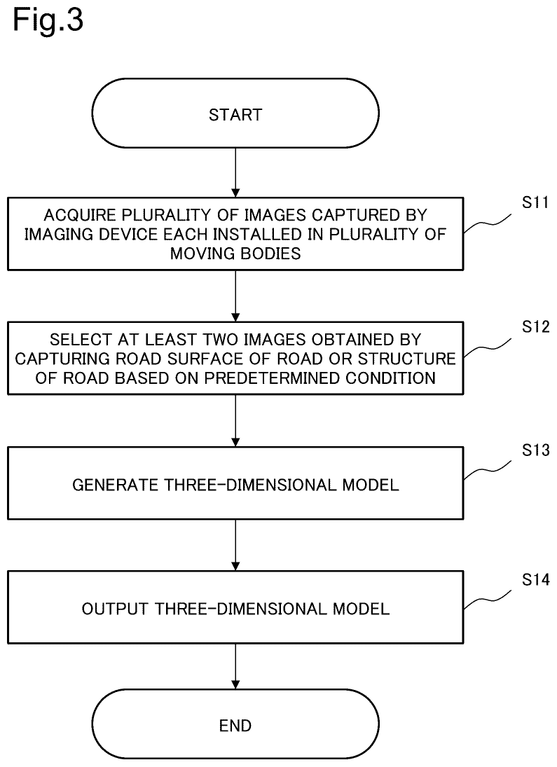

FIG. 3 is a flowchart illustrating an operation example of the three-dimensionalization system 100 according to the first example embodiment. The three-dimensionalization system 100 may start the operation of FIG. 3 according to the operation of the user using the input device 21.

The acquisition unit 110 acquires a plurality of images captured by the imaging device 10 installed in each of the plurality of moving bodies 11 (step S11).

The selection unit 120 selects at least two images obtained by capturing a road surface of a road or a structure on the road based on a predetermined condition from the plurality of images acquired by the acquisition unit 110 (step S12).

The generation unit 130 uses the images selected by the selection unit 120 to generate a three-dimensional model of a captured road surface of a road or a captured structure on the road (step S13).

The output unit 140 outputs information to the display 20 based on the generated three-dimensional model (step S14).

According to the first example embodiment, the acquisition unit 110 acquires a plurality of images captured by the imaging device 10 installed in each of the plurality of moving bodies 11. Then, the selection unit 120 selects at least two images obtained by capturing a road surface of a road or a structure on the road based on a predetermined condition from the plurality of images acquired by the acquisition unit 110. The generation unit 130 uses the images selected by the selection unit 120 to generate a three-dimensional model of a captured road surface of a road or a captured structure on the road. Since an image suitable for generating a three-dimensional model is selected based on a predetermined condition, according to the first example embodiment, it is possible to generate a highly accurate three-dimensional model.

In order to measure the situation of the road surface, a stereo camera or a light cutting capturing device that emits a slit laser is provided in the moving body 11. PTL 2 discloses an imaging system that creates three-dimensional road surface data based on an image captured by a stereo camera. However, the stereo camera and the light cutting capturing device are expensive. According to the first example embodiment, a situation of a road can be analyzed using an image captured by a monocular camera such as a drive recorder. Therefore, according to the first example embodiment, the image required for the three-dimensional model can be collected at low cost.

PTL 3 discloses an image processing device that improves convenience of a technique for performing distance measurement by a motion stereo method using a monocular camera. It has been difficult to estimate the depth of road deterioration from an image captured by a monocular camera such as a drive recorder. In particular, since the cracks of the road surface are small, it is difficult to estimate the depth of the cracks. In order to analyze the depth of road deterioration, it is necessary to make an image three-dimensional with high accuracy. According to the first example embodiment, an image suitable for estimating the depth of road deterioration is selected from images captured by the imaging device 10 installed in each of the plurality of moving bodies 11. Then, using the selected image, the generation unit 130 generates a three-dimensional model representing the depth of road deterioration. Therefore, according to the first example embodiment, it is possible to support creation of a repair plan based on the depth of road deterioration such as cracking, pot holes, or rutting while reducing the cost.

### Second Example Embodiment

Next, as a second example embodiment, the three-dimensionalization system 100 will be described in more detail. Regarding the configuration of the second example embodiment, description of the same configuration as that of the first example embodiment will be omitted.

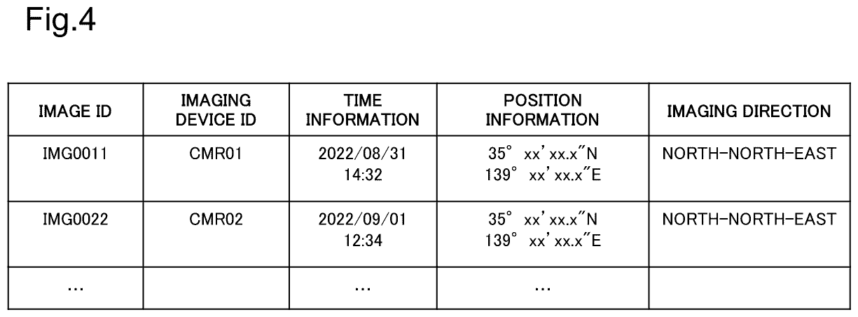

In the second example embodiment, the acquisition unit 110 acquires imaging data including an image obtained by capturing a predetermined point. FIG. 4 is a table illustrating an example of information included in imaging data. The imaging data in FIG. 4 includes an image identifier (ID), an imaging device ID, time information, position information, and an imaging direction. The image ID is an identifier for identifying an image. The image ID may be an identifier for specifying one frame of the moving image. The imaging device ID is an identifier for identifying the imaging device 10 that has captured an image. The imaging data may not include the information illustrated in FIG. 4, and may include information other than the information illustrated.

Here, an example of a predetermined condition for selecting at least two images suitable for generating a three-dimensional model of a road surface of a road or a structure on the road will be described. The selection unit 120 may select an image based on an arbitrary combination of conditions described below.

In one example, the predetermined condition is a condition related to image similarity. The selection unit 120 may select an image from the plurality of images based on the similarity of the images. The image similarity is calculated by any method. Compared with similarity between images obtained by capturing different objects from different viewpoints at the same point, similarity between images obtained by capturing the same object from close viewpoints at the same point is high.

For example, the selection unit 120 selects at least two images having similarity higher than a threshold (lower limit). Two images having a similarity higher than the threshold have the same capturing range, and there is a high possibility that the same object is captured. Therefore, the distance can be calculated based on the parallax of the object. In a case where the similarity between the images is low, the difference in the capturing range is too large, and thus the parallax information is insufficient, and it may be difficult to calculate the distance.

The brightness and color of an image may differ depending on sunshine conditions. Therefore, in order to estimate the difference in the capturing range from the similarity, the similarity of the image may be calculated after the brightness and the color of the image are converted. In a case where images are selected under the same sunshine conditions, the similarity is calculated as it is without converting the images.

The selection unit 120 may select an image such that the image is included in at least two images having similarity lower than the threshold upper limit. This is because it is difficult to calculate the distance even in a case where the similarity between the images is high and the overlap of the capturing ranges is too large. When the selection unit 120 selects an image having a similarity lower than the threshold upper limit, images captured from different viewpoints by the imaging devices 10 of the plurality of moving bodies 11 can be selected.

In another example, the predetermined condition is a condition related to the imaging device 10 that has captured an image. The selection unit 120 may select an image so as to include images captured by different imaging devices 10 installed in different moving bodies 11.

At this time, the selection unit 120 refers to, for example, the imaging device ID of the imaging data. By selecting images captured by the imaging devices 10 installed in different moving bodies 11, it is expected to obtain a larger parallax than images captured by the same moving body 11 passing through the road several times. Therefore, it is possible to calculate the distance with higher accuracy.

However, the selection unit 120 may select at least two images captured by the imaging device 10 by traveling at a predetermined point a plurality of times by one moving body 11. This is because parallax information can be obtained between at least two images in a case where the traveling positions of a predetermined point on the road at the first and second times are different. That is, the selection unit 120 may select at least two images captured at different dates and times for a predetermined time or more by the imaging device 10 installed in the same moving body 11. Then, the selection unit 120 may exclude at least two images continuously captured by the imaging device 10 while one moving body 11 is traveling from the target to be selected. Only parallax information relevant to one frame of movement of the moving body 11 can be obtained from the two images captured continuously. Therefore, the continuously capturing images may not be suitable for generating a three-dimensional model.

In another example, the predetermined condition is a condition related to the installation state of the imaging device 10. The installation state of the imaging device 10 includes the installation height, the installation angle or the left-right position with respect to the moving body 11, and the type of the moving body 11 installed. The selection unit 120 may select an image based on the installation state of the imaging device 10. For example, the selection unit 120 selects images captured by the imaging devices 10 in different installation states. As a result, the selection unit 120 can select an image having parallax. The installation state of the imaging device 10 is stored in the database 40 in association with the imaging device ID.

The installation height may be represented by the height of the imaging device 10 installed on the moving body 11 from the ground. The installation height may be represented by a distance of the imaging device with respect to a predetermined member of the moving body 11.

The installation angle indicates at what angle the imaging device 10 is installed to capture an image. The installation angle may be represented by an elevation angle or a depression angle. The installation angle may be represented by an orientation of the imaging device 10 with respect to the front direction of the moving body 11.

The type of the installed moving body 11 may be specified by a size or a vehicle type of an automobile which is the moving body 11. The type of the moving body 11 may be specified by whether the moving body 11 is any one of a four-wheeled automobile, a two-wheeled automobile, a bicycle, and a drone. For example, the selection unit 120 may select an image captured by the imaging device 10 installed in each of a normal automobile and a bus. Since the size of the ordinary automobile is different from that of the bus, images from different viewpoints can be selected from the imaging devices 10 installed in the normal vehicle and the bus.

A left-right position with respect to the moving body 11 may be used as the installation state of the imaging device 10. The left-right position indicates, for example, at which position in the width direction of the vehicle that is the moving body 11 the imaging device 10 is installed. The left-right position may be represented by a distance from the center of the vehicle.

In another example, the predetermined condition is a condition regarding an imaging direction included in the imaging data. The imaging direction is an azimuth or an elevation/depression angle that can be acquired by a sensor included in the imaging device 10 and that the imaging device 10 faces. The selection unit 120 may select an image based on such an imaging direction. For example, the selection unit 120 selects images with different imaging directions. As a result, the selection unit 120 can select an image having parallax.

As another example, the predetermined condition may be a condition related to an imaging direction with respect to an object included in an image. The selection unit 120 may select an image based on an imaging direction with respect to an object specified by recognizing the object by image analysis. The imaging direction with respect to the object indicates a positional relationship between the imaging device 10 and the object included in the image. The objects included in the image include, for example, road deterioration such as cracking and pot holes, road surface markings such as section lines, and structures on the road.

The selection unit 120 may select an image obtained by capturing cracking from a plurality of directions based on the imaging direction of the cracking. As a result, the selection unit 120 can select an image suitable for accurately estimating the depth of cracking. According to the imaging direction with respect to the dividing line, the traveling position of the moving body 11 in the lane is grasped. When the selection unit 120 selects an image based on the imaging direction with respect to the dividing line, the selection unit 120 can select an image captured when the vehicle travels at a different position in the lane. Therefore, the selection unit 120 can select an image having parallax.

As another example, the predetermined condition may be a condition related to bias of the imaging data. When the selection unit 120 selects more images, it is expected that the generation unit 130 can generate a higher-accuracy three-dimensional model by using the selected images. However, in the present disclosure, since an image automatically captured by a drive recorder of a vehicle that travels on a daily basis can be used, many similar images can be captured for a predetermined point. Even if many similar images are selected, the accuracy of the three-dimensional model is not improved. Therefore, the selection unit 120 may select images captured from various viewpoints in a well-balanced manner based on the bias of the imaging data as follows.

For example, the selection unit 120 may select an image so as to reduce the bias of the similarity of the image. The selection unit 120 may select an image such that a bias between an image having a large similarity and an image having a small similarity becomes small.

The selection unit 120 may select an image so as to reduce the bias in the installation state. For example, in a case where there are many pieces of imaging data of the imaging device 10 installed in a normal automobile, there are many images captured from a low viewpoint. Therefore, the selection unit 120 uniformly selects an image captured from a higher viewpoint by the imaging device 10 installed in a bus, a garbage collection vehicle, or the like.

In another example, the predetermined condition is a condition related to the presence or absence of road deterioration in the road in the image. The selection unit 120 may select an image from which road deterioration can be detected. The selection unit 120 may select more images in a region with road deterioration than in a region without road deterioration based on the presence or absence of road deterioration. As a result, the generation unit 130 can represent the depth of road deterioration with higher accuracy using more images.

Here, one specific example in which a plurality of conditions are combined will be described. The selection unit 120 selects, for example, a plurality of images capable of detecting road deterioration from among images obtained by capturing a predetermined point. Then, the selection unit 120 further selects an image suitable for generating a three-dimensional model of road deterioration based on the similarity between the selected images. Therefore, the selection unit 120 selects at least two similar images from among images showing road deterioration well. As a result, the generation unit 130 can generate a three-dimensional model of road deterioration of the road surface with high accuracy.

In addition, the selection unit 120 may select an image based on various types of information. For example, the selection unit 120 may select an image based on time information of imaging data. The selection unit 120 may select images captured in the same time zone. The selection unit 120 may select an image captured in a time period in which there are few shadows due to road deterioration, such as daytime. The selection unit 120 may further select images captured in the same weather based on weather information of the date and time when the images have been captured. The selection unit 120 may select images captured by the imaging devices 10 of the same model.

The predetermined condition under which the selection unit 120 selects an image suitable for generating the three-dimensional model of the road surface of a road or the structure on the road has been described above. Next, generation of the three-dimensional model by the generation unit 130 will be described.

The generation unit 130 performs matching processing of relevant points of the image selected by the selection unit 120. The generation unit 130 obtains, for a certain reference pixel in one image, a relevant pixel in another image by an arbitrary matching algorithm. For example, the generation unit 130 extracts feature points from the images and associates the feature points between the images. In order to eliminate the influence of the sunshine condition, the generation unit 130 may perform matching by converting the brightness and color of the image. The generation unit 130 may use the information on the imaging direction and the installation state included in the imaging data for matching the relevant points.

The generation unit 130 may detect an area with road deterioration and perform matching processing on the detected area with road deterioration. The generation unit 130 detects road deterioration using a known image recognition technique for an image. The generation unit 130 may detect road deterioration using the learned model. The generation unit 130 may determine whether there is road deterioration for each pixel of the image. Then, the generation unit 130 associates points representing road deterioration between the images. For example, the generation unit 130 may detect an area of cracking from each of the two images and obtain relevant pixels of the detected cracks.

The generation unit 130 may detect a road area and perform matching processing on the detected road area. As a result, for example, the generation unit 130 can prevent matching between a road area in one image and a building area in the other image.

Then, the generation unit 130 calculates three-dimensional coordinates of the points associated between the images based on the imaging data. For example, the generation unit 130 calculates the distance by the principle of triangulation based on the focal length of the imaging device 10, the parallax between the matched reference pixel and the relevant pixel, and the distance between the imaging devices 10 that have captured images. The generation unit 130 generates three-dimensional point group information based on the distance calculated for each pixel. The distance between the imaging devices 10 that have captured images is a parameter necessary for processing parallax of the images, and is also referred to as a baseline length.

The generation unit 130 calculates the baseline length based on imaging conditions included in the imaging data, such as the installation state of the imaging device 10 and the imaging direction of the image. The generation unit 130 may calculate the baseline length based on the position, which is estimated from the image, on the road of the imaging device 10 at the time of capturing. The position on the road is estimated from the appearance of a reference object in the image. The left and right positions on the road are estimated, for example, based on how the lane lines look.

The generation unit 130 may convert the three-dimensional point group information so that the three-dimensional point group information can be easily visually recognized. For example, the generation unit 130 performs texture mapping by pasting a region surrounded by three feature points in the vicinity of the image to three points of three-dimensional coordinates formed by the three feature points. As a result, the generation unit 130 can generate the three-dimensional model configured by the triangular polygon surface.

According to the second example embodiment, similarly to the first example embodiment, it is possible to generate a highly accurate three-dimensional model.

### Hardware Configuration

In the above-described example embodiment, each component of the three-dimensionalization system 100 represents a block of functional units. A part or all of each component of the three-dimensionalization system 100 may be achieved by any combination of a computer 500 and the program.

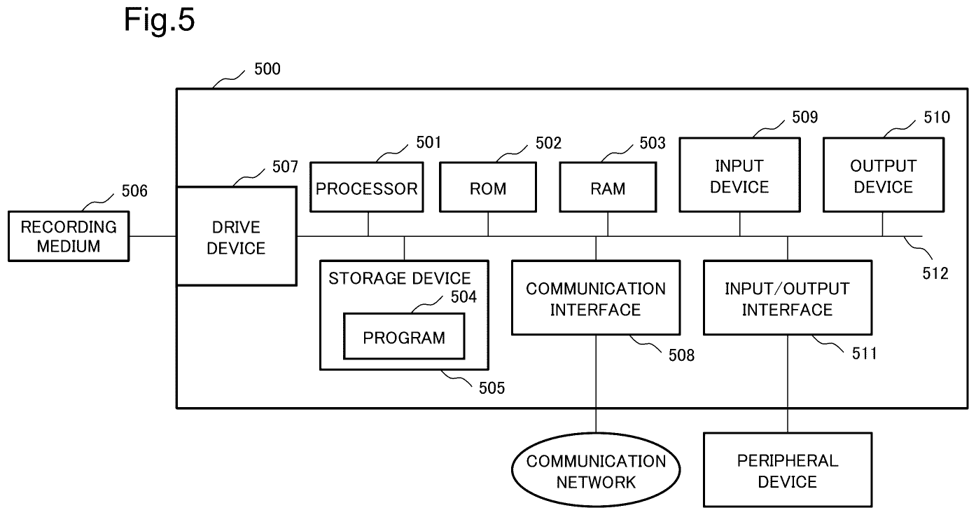

FIG. 5 is a block diagram illustrating an exemplary hardware configuration of the computer 500. Referring to FIG. 5, the computer 500 includes, for example, a processor 501, a read only memory (ROM) 502, a random access memory (RAM) 503, a program 504, a storage device 505, a drive device 507, a communication interface 508, an input device 509, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes an instruction for achieving each function of the three-dimensionalization system 100. The program 504 is stored in advance in the ROM 502, the RAM 503, and the storage device 505. The processor 501 achieves each function of the three-dimensionalization system 100 by executing instructions included in the program 504. The RAM 503 may store data to be processed in each function of the three-dimensionalization system 100. For example, the captured image may be stored in the RAM 503 of the computer 500.

The drive device 507 reads and writes a recording medium 506. The communication interface 508 provides an interface with a communication network. The input device 509 is, for example, a mouse, a keyboard, or the like, and receives an input of information from the administrator. The output device 510 is, for example, a display, and outputs (displays) information to an administrator or the like. The input/output interface 511 provides an interface with a peripheral device. The bus 512 connects the components of the hardware. The program 504 may be supplied to the processor 501 via the communication network, or may be stored in advance in the recording medium 506, and the drive device 507 may read the program and supply the program to the processor 501.

The hardware configuration illustrated in FIG. 5 is an example, and other components may be added or some components may not be included.

There are various modifications of the implementation method of the three-dimensionalization system 100. For example, the three-dimensionalization system 100 may be achieved by an arbitrary combination of a computer and a program different for each component. A plurality of components included in the three-dimensionalization system 100 may be achieved by any combination of one computer and a program.

At least a part of the three-dimensionalization system 100 may be provided in a software as a service (SaaS) format. That is, at least a part of the functions for realizing the three-dimensionalization system 100 may be executed by software executed via a network.

Although the present disclosure has been particularly shown and described with reference to the present example embodiment, the present disclosure is not limited to the above example embodiment. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

### Reference Signs List

100 three-dimensionalization system
110 acquisition unit
120 selection unit
130 generation unit
140 output unit
10 imaging device
20 display
21 input device
30 communication network
40 database

What is claimed is:

1. A three-dimensionalization system comprising:
at least one memory storing instructions; and
at least one processor configured to execute the instructions to:
acquire a plurality of images captured by imaging devices each installed on each of a plurality of moving bodies;
select at least two images obtained by capturing a road surface of a road or a structure on the road from among the plurality of acquired images based on a predetermined condition; and
generate a three-dimensional model of the captured road surface of the road or the captured structure on the road using the selected images.

2. The three-dimensionalization system according to claim 1, wherein the at least one processor is further configured to execute the instructions to:
select the image based on a similarity of the image.

3. The three-dimensionalization system according to claim 1, wherein the at least one processor is further configured to execute the instructions to:
select the selection means selects the image based on an installation state of the imaging device.

4. The three-dimensionalization system according to claim 1, wherein the at least one processor is further configured to execute the instructions to:
select the image based on an imaging direction with respect to an object included in the image.

5. The three-dimensionalization system according to claim 1, wherein the at least one processor is further configured to execute the instructions to:
select the image based on a type of the moving body in which the imaging device is installed.

6. The three-dimensionalization system according to claim 2, wherein the at least one processor is further configured to execute the instructions to:
select the image so as to reduce a bias in similarity of the image.

7. The three-dimensionalization system according to claim 1, wherein the at least one processor is further configured to execute the instructions to:
select the image suitable for estimating a depth of road deterioration, and
generate the three-dimensional model indicating a depth of road deterioration of the captured road surface of the road.

8. The three-dimensionalization system according to claim 7, wherein the at least one processor is further configured to execute the instructions to:
select the image capable of detecting road deterioration.

9. A three-dimensionalization method comprising:
acquiring a plurality of images captured by imaging devices each installed on each of a plurality of moving bodies;
selecting at least two images obtained by capturing a road surface of a road or a structure on the road from among the plurality of acquired images based on a predetermined condition; and
generating a three-dimensional model of the captured road surface of the road or the captured structure on the road using the selected images.

10. A non-transitory recording medium having stored therein a program for causing a computer to execute:
acquiring a plurality of images captured by imaging devices each installed on each of a plurality of moving bodies;
selecting at least two images obtained by capturing a road surface of a road or a structure on the road from among the plurality of acquired images based on a predetermined condition; and
generating a three-dimensional model of the captured road surface of the road or the captured structure on the road using the selected images.
